(19) United States
(12) Patent Application Publication
(10) Pub. No.: US 2008/0078639 A1
(43) Pub. Date: Apr. 3, 2008

(54) Power transmission device

(75) Inventors: Atsushi Ogasawara, Saitama (JP); Toshimasa Mitsubori, Saitama (JP)

Correspondence Address: BIRCH STEWART KOLASCH & BIRCH, PO BOX 747, FALLS CHURCH, VA, 22040-0747, US

(73) Assignee: HONDA MOTOR CO., LTD.

(21) Appl. No.: 11/905,123

(22) Filed: Sep. 27, 2007

(30) Foreign Application Priority Data
Sep. 29, 2006 (JP) 2006-270056

(51) Int. Cl. B60W 10/02

(52) U.S. Cl. 192/3.57

(57) ABSTRACT

A power transmission device for transmitting power of an internal combustion engine of a saddle-ride type vehicle such as a motorcycle to an output side by way of a transmission includes a start clutch for connecting power transmitted from the transmission to an output side when the saddle-ride-type vehicle starts and disconnects the power when the saddle-ride-type vehicle stops, wherein the transmission device can reduce a load applied to the internal combustion engine at the time of starting the saddle-ride-type vehicle and can suppress the increase of a lateral width of the internal combustion engine. The power transmission device includes, in addition to a start clutch, a transmission input clutch for disconnecting power transmitted from an internal combustion engine to a transmission when the internal combustion engine starts. The transmission input clutch is arranged on a drive pulley shaft of a continuously variable transmission.

An internal combustion engine being characterized in that a power transmission chamber is arranged behind a crank chamber of an engine body in a state that the power transmission chamber is integrally formed with the crank chamber, an oil pan which receives oil for lubricating the engine body and respective members which constitute a power transmission system is mounted on a lowermost portion of a chamber which functions as the crank chamber as well as the power transmission chamber integrally formed with each other, a wet belt-type automatic transmission which is connected to the engine body and includes a drive pulley and a driven pulley is arranged in the power transmission chamber, and the drive pulley and the driven pulley are arranged in a vertically displaced manner such that rotation axes of the drive pulley and the driven pulley are arranged parallel to an axis of the crankshaft and both pulleys overlap each other as viewed from above.

### CROSS-REFERENCE TO RELATED APPLICATIONS

The present application claims priority under 35 USC 119 to Japanese Patent Application No. 2006-270056 filed on Sep. 29, 2006 the entire contents of which are hereby incorporated by reference.

### BACKGROUND OF THE INVENTION

1. Field of the Invention

The present invention relates to a power transmission device for transmitting power from an internal combustion engine of a motorcycle toward a rear wheel. More particularly, to a power transmission device which includes a hydraulically-controlled continuously variable transmission (abbreviated as CVT).

2. Description of Background Art

A conventional continuously variable transmission for a motorcycle includes a start clutch which connects the power when the motorcycle starts and disconnects the power when the motorcycle stops. The continuously variable transmission is arranged behind a crankshaft and the start clutch is provided on a drive pulley shaft of the continuously variable transmission. See, for example, JP-A-63-103784 FIG. 3.

In a conventional example, when a crankshaft is rotated at the time of starting an internal combustion engine, a power transmission mechanism (a primary chain 17 and sprocket wheels 28, 29 in the above-mentioned patent document) is rotated thus rotating a start clutch.

### SUMMARY AND OBJECTS OF THE INVENTION

It is an object of the invention to provide a power transmission device to reduce a load at the time of starting a motorcycle or the like in the prior art, to suppress the increase of a lateral width of an internal combustion engine and for exhibiting favorable operability.

According to an embodiment of the present invention, a power transmission device transmits power from an internal combustion engine of a saddle-ride type vehicle such as a motorcycle to an output side by way of a transmission and includes a start clutch which connects the power transmitted from the transmission to the output side when the saddle-ride-type vehicle starts and disconnects the power when the saddle-ride-type vehicle stops. The power transmission device includes, in addition to the start clutch, a transmission input clutch which disconnects the power transmitted from the internal combustion engine to the transmission when the internal combustion engine starts.

According to an embodiment of the present invention, a continuously variable transmission is arranged between a crankshaft and a transmission output shaft in a side view of a power unit. At the same time, the transmission input clutch which disconnects the power when the internal combustion engine starts is arranged on a drive pulley shaft of the continuously variable transmission.

According to an embodiment of the present invention, a transmission input clutch is arranged in another chamber isolated from the continuously variable transmission.

According to an embodiment of the present invention, a continuously variable transmission is driven using oil for the continuously variable transmission and the transmission input clutch that is driven using engine oil.

According to an embodiment of the present invention, a transmission input clutch is arranged in the same chamber as the continuously variable transmission.

According to an embodiment of the present invention, the drive pulley of the continuously variable transmission is arranged on another shaft behind the crankshaft at the approximately center in the lateral direction of the power unit and the drive pulley and a driven pulley of the continuously variable transmission are configured to take positions arranged in the vertical direction.

According to an embodiment of the present invention, by providing the transmission input clutch which disconnects the power transmitted from the internal combustion engine to the transmission, a load applied to the starting device when the internal combustion engine starts can be reduced and, at the same time, the CVT can be protected.

According to an embodiment of the present invention, by arranging the drive pulley of the continuously variable transmission on another shaft than the crankshaft and by providing the transmission input clutch in the power input portion of the drive pulley shaft, the increase in the width of the power unit can be suppressed.

According to an embodiment of the present invention, with the use of the partitioning wall for isolating the continuously variable transmission and the transmission input clutch from each other, it is possible to separate the working oil for driving the movable half body of the continuously variable transmission and the lubricating oil for driving the transmission input clutch thus preventing the mixing of the operating oil and the lubricating oil. Thus, the performance of the oils can be optimized.

According to an embodiment of the present invention, with the use of optimum oils for the respective devices, it is possible to allow the respective devices to exhibit excellent performances.

According to an embodiment of the present invention, by providing the transmission input clutch in the same chamber of the continuously variable transmission, the same oil can be used for the continuously variable transmission and the clutch thus simplifying the control mechanism.

According to an embodiment of the present invention, by arranging the drive pulley of the continuously variable transmission on another shaft behind the crankshaft and approximately at the center in the lateral direction of the power unit, it is possible to suppress the increase of the lateral width of the power unit. Further, even in the above-mentioned arrangement, when the drive pulley and the driven pulley are arranged in the longitudinal direction of the vehicle, the power unit is elongated in the longitudinal direction. Accordingly, the drive pulley and the driven pulley are arranged in the vertical direction. Thus, a longitudinal length of the power unit can be shortened. Due to such a constitution, both of the lateral width and the longitudinal length of the power unit can be shortened.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side view of a motorcycle wherein a power unit is mounted according to embodiments of the invention;

FIG. 2 is a right side view of the power unit according to a first embodiment of the invention;

FIG. 3 is a left side view of the above-mentioned power unit;

FIG. 4 is a cross-sectional developed view taken along a line IV-IV in FIG. 2;

FIG. 5 is a right side view of a power unit according to a second embodiment of the invention;

FIG. 6 is a left side view of a power unit according to a third embodiment of the invention; and

FIG. 7 is a cross-sectional developed view of a power unit according to a fourth embodiment of the invention which includes respective rotational shafts.

### DETAILED DESCRIPTION OF THE PREFERRED EMBODIMENTS

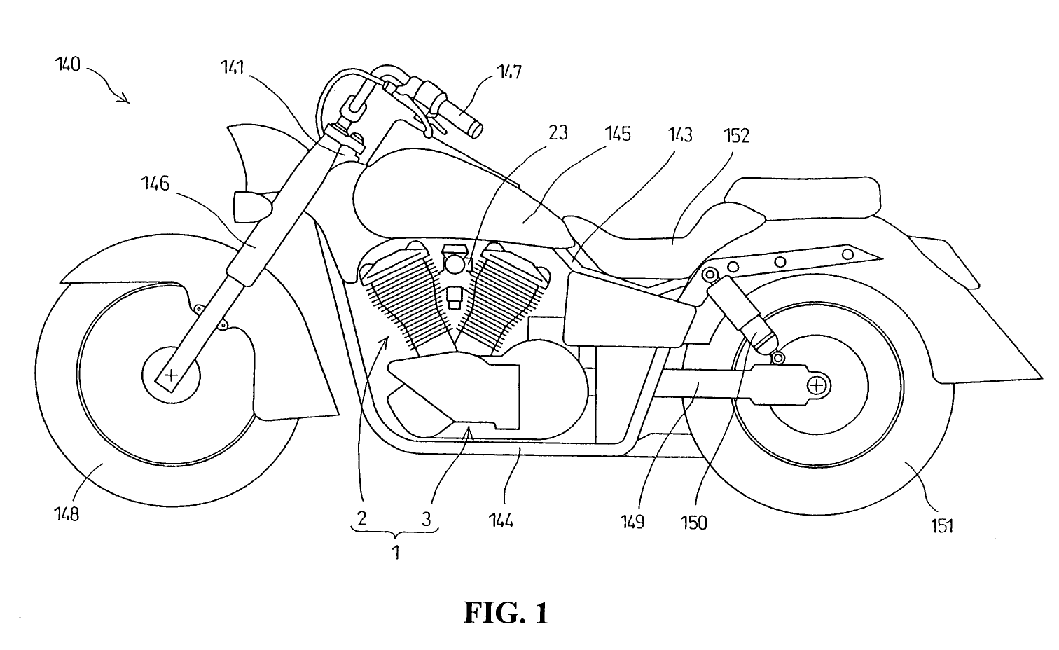

FIG. 1 is a side view of a motorcycle 140 wherein a power unit 1 according to the invention is mounted thereon. A vehicle structure body of the motorcycle 140 is configured such that a main frame (not shown in the drawing) extends rearwardly from a head pipe 141 mounted on a front end of the motorcycle 140 and, at the same time, a rear frame 143 which extends obliquely and downwardly from a rear portion of the main frame is connected to the main frame, and a down frame 144 extends downwardly and rearwardly from the head pipe 141. A rear end portion of the down frame 144 is bent upwardly and is connected to the rear frame 143. A fuel tank 145 is formed in a state that the fuel tank 145 strides over the main frame (not shown in the drawing). Between the main frame, the rear frame 143 and the down frame 144, a power unit 1, which is integrally formed of an internal combustion engine 2 and a transmission 3, is mounted. A front fork 146 is rotatably supported on the head pipe 141, a steering handle 147 is mounted on an upper end of the front fork 146, and a front wheel 148 is pivotally supported on a lower end of the front fork 146. Front ends of a pair of rear forks 149 are pivotally supported on a rear portion of the down frame 144 in a state wherein the rear forks 149 are tiltable in the vertical direction. A rear shock absorber unit 150 is provided between a rear portion of the rear fork 149 and a rear end portion of the rear fame 143. A rear wheel 151 is pivotally supported on a rear end of the rear fork 149.

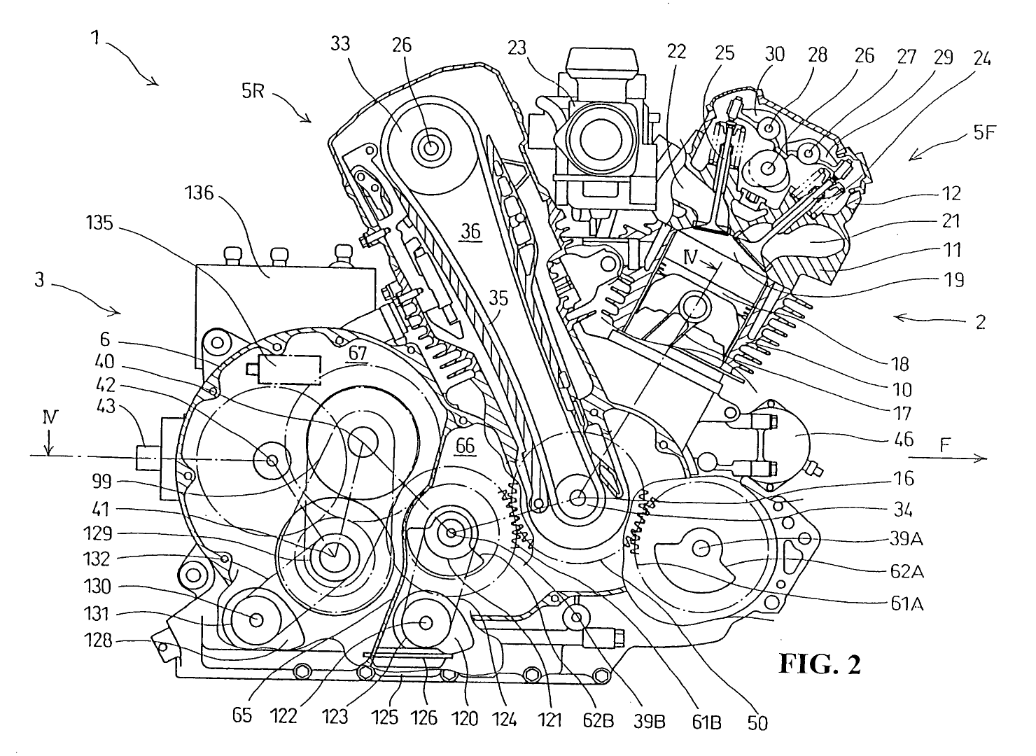

The above-mentioned internal combustion engine 2 is a water-cooled V-shaped double-cylinder internal combustion engine in which cylinders are arranged to form a V-shape in the longitudinal direction. A throttle body 23 having an electronic throttle valve is arranged in a space defined between both cylinders which forms a V-bank and is connected to intake ports of the front and rear cylinders via a manifold. A crankshaft of the internal combustion engine 2 is arranged orthogonal to the vehicle advancing direction and is arranged horizontally in the lateral direction of the vehicle. A transmission shaft of the transmission 3 is arranged in parallel to the above-mentioned crankshaft 16 (FIG. 2). An extension shaft for driving the rear wheel (not shown in the drawing) is connected to a connection shaft 43 (FIG. 2) arranged orthogonal to an output shaft of the transmission, extends toward a rear portion of the vehicle, and arrives at a rotary shaft of the rear wheel 151 thus driving the rear wheel 151. A seat 152 is mounted on a rear portion of the fuel tank 145.

FIGS. 2-4 are views showing the power unit according to a first embodiment of the invention. FIG. 2 is a right side view of the power unit 1. The drawing shows the power unit wherein a right-side power unit casing is removed and a cross-section of the cylinder is illustrated. The power unit 1 is constituted of the internal combustion engine 2 and the transmission 3. An arrow F indicates a front side of the power unit 1 when the power unit 1 is mounted on the vehicle (The same goes for other drawings). The internal combustion engine 2 is a water-cooled V-shaped 2-cylinder internal combustion engine, and the cylinders are arranged to form a V-shape in the longitudinal direction. The crankshaft 16 of the above-mentioned internal combustion engine 2 is arranged orthogonal to the vehicle advancing direction and is arranged horizontally in the lateral direction of the vehicle. A front balancer shaft 39A and a rear balancer shaft 39B are arranged in front of and behind the crankshaft 16 respectively, and the transmission 3 is arranged behind the rear balancer shaft 39B. A front balancer 62A and a rear balancer 62B are mounted on the front balancer shaft 39A and the rear balancer shaft 39B respectively (FIG. 2). These balancers 62A, 62B are primary balancers and are rotated at the same rotational speed as the crankshaft 16.

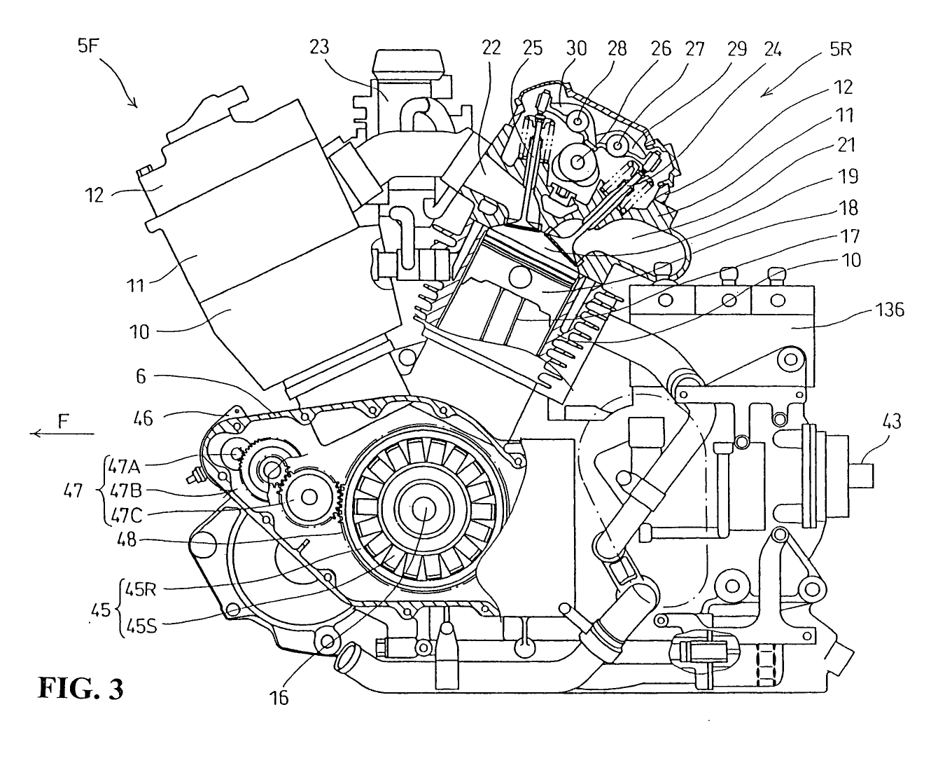

FIG. 3 is a left side view of the power unit 1. The drawing shows a state of the power unit in which a portion of a left-side unit cover is removed and a cross-section of the rear cylinder is illustrated.

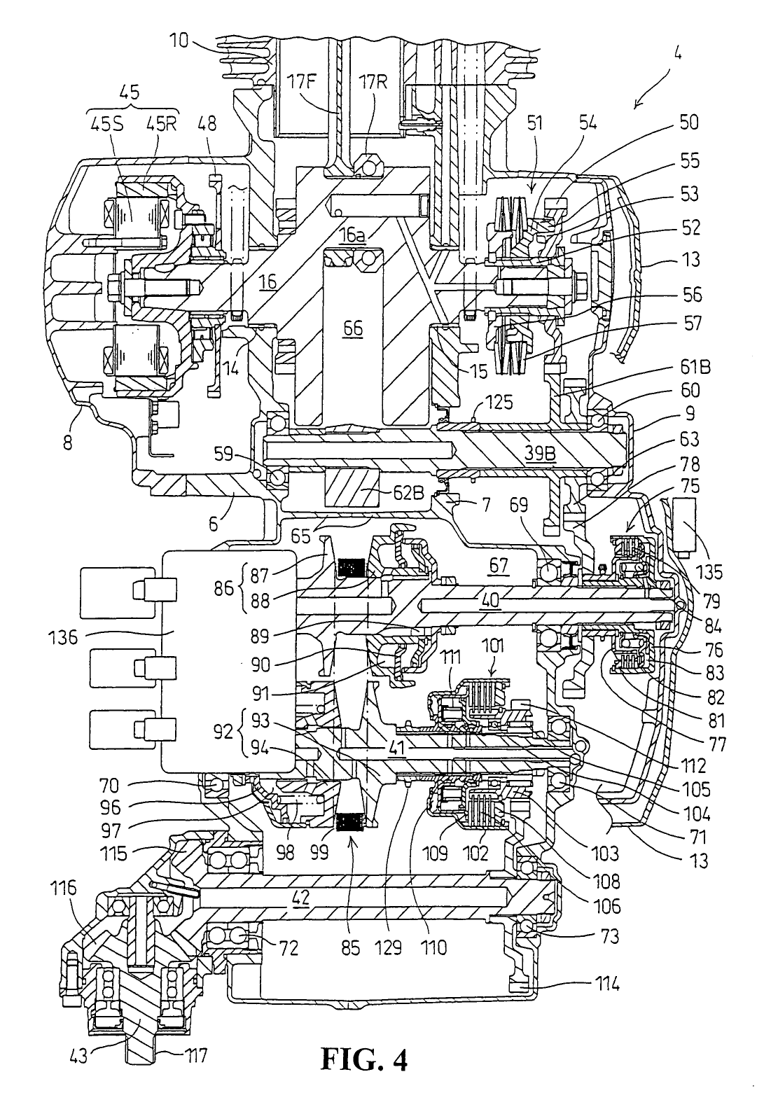

FIG. 4 is a cross-sectional developed view taken along a line IV-IV in FIG. 2. The view shows the power transmission device 4 from the crankshaft 16 to the connection shaft 43 arranged on a rear end of the power transmission device 4. The following explanation is made alternately referring to the respective above-mentioned views.

A main outer shell of the power unit 1 includes a left power unit casing 6, a right power unit casing 7, a left unit cover 8, a right unit cover 9, a right outer protecting cover 13 shown in FIG. 4, and cylinder blocks 10, cylinder heads 11 and cylinder head covers 12 which are respectively mounted on a front cylinder 5F and a rear cylinder 5R shown in FIGS. 2 and 3. A power unit casing which covers a crank chamber 66 and a transmission chamber 67 includes the left power unit casing 6, the right power unit casing 7, the left unit cover 8, the right unit cover 9 and the right outer protecting cover 13. Here, a front half portion of the power unit casing forms a crank casing and a rear half portion of the power unit casing forms a transmission casing.

In FIG. 4, the crankshaft 16 is rotatably supported on a left journal bearing 14 and a right journal bearing 15 which are held by the left and right power unit casings 6, 7. A connecting rod 17F of the front (left) cylinder and a connecting rod 17R of the rear (right) cylinder are connected to a crank pin 16a of the crankshaft 16 in a state wherein the connecting rods 17F, 17R are arranged close to each other. As shown in FIGS. 2 and 3, a piston 18 is joined to each connecting rod 17, and the piston 18 is slidably held in a cylinder bore formed in the cylinder block 10. A combustion chamber 19 is formed in a portion of the cylinder head 11 which faces the piston 18 in an opposed manner, and an ignition plug (not shown in the drawing), which penetrates a wall body of the cylinder head 11, allows a distal end thereof to face the combustion chamber 19, and allows a rear end thereof to be exposed to the outside.

In FIGS. 2 and 3, an exhaust port 21 and the intake port 22 are communicably connected with the combustion chamber 19. The exhaust port 21 extends to the front in the front cylinder 5F and extends rearwardly in the rear cylinder 5R. The intake port 22 of either one of cylinders extends into a space between both cylinders formed in a V bank, is connected to a throttle body 23 having the electronic throttle valve and hence, fuel and air are supplied to the intake port 22. An exhaust valve 24 is formed in the exhaust port 21 and an intake valve 25 is formed in the intake port 22. A cam shaft 26 is arranged in the inside of the cylinder head cover 12, an exhaust rocker arm shaft 27 and an intake rocker arm shaft 28 are arranged above the cam shaft 26. An exhaust rocker arm 29 and an intake rocker arm 30 which are mounted on these arm shafts are driven by an exhaust cam and an intake cam of the cam shaft 26 thus pushing stem top portions of the above-mentioned exhaust valve 24 and intake valve 25 so as to open or close the respective valves. In FIG. 2, the cam shaft 26 is rotatably driven at a rotational speed which is ½ of a rotational speed of the crankshaft 16 using a cam shaft drive chain 35 which extends between and is wound around a cam shaft driven sprocket wheel 33 which is mounted on an end portion of the cam shaft 26 and a cam shaft drive sprocket wheel 34 which is mounted on the crankshaft 16. In FIG. 2, a cam chain chamber 36 is shown.

In FIG. 2, in the power unit 1, the front balancer shaft 39A and the rear balancer shaft 39B are arranged in front of and behind the crankshaft 16 respectively, and three transmission shafts, that is, a CVT drive shaft 40, a CVT driven shaft 41 and a transmission output shaft 42 which are arranged in parallel to the crankshaft are arranged behind the rear balancer shaft 39B. Further, a connection shaft 43 which is connected to the extension shaft for driving the rear wheel (not shown in the drawing) is arranged rearwardly orthogonal to the transmission output shaft 42.

In FIG. 4, the left unit cover 8 is arranged outside the left power unit casing 6, and a power generator 45 includes a stator 45S which is fixed to an inner surface of the left unit cover 8 and a rotor 45R which is fixed to a left end of the crankshaft 16 and surrounds the stator 45S. A gear 48 shown in FIG. 4, which is arranged close to the power generator 45, is a starter driven gear 48 (FIG. 3, FIG. 4) for the crankshaft 16 which receives a rotational drive force from a starter motor 46 (FIG. 2, FIG. 3) by way of a gear train 47 (FIG. 3). The gear train 47 includes a starter pinion gear 47A, a first idle gear 47B and a second idle gear 47C and is connected to the starter driven gear 48.

A crankshaft output gear 50 is formed on a right end portion of the crankshaft 16 for functioning in combination with a neighboring cam-type torque damper 51, and is meshed with respective balancer shaft input gears 61A, 61B (FIG. 2) which are mounted on the front balancer shaft 39A and the rear balancer shaft 39B so as to perform the power transmission at a rotational speed of 1:1.

The crankshaft output gear 50 and the cam-type torque damper 51 are mounted on a collar 52 which is engaged with the crankshaft 16 by spline fitting. The crankshaft output gear 50 is rotatably fitted on the collar 52, and a concave cam 53 having an arcuate concave surface is formed on a side surface of the crankshaft output gear 50. A lifter 54 is fitted on a spline formed on an outer periphery of the collar 52 in a state that the lifter 5 is movable in the axial direction. A convex cam 55 having an arcuate convex surface is formed on an end surface of the lifter 54, and the convex cam 55 is fitted in the concave cam 53. A spring holder 56 is fixed to an end portion of the collar 52 using the spline and a retainer ring. A coned disc spring 57 is provided between a spring holder 56 and the lifter 54 so as to bias the convex cam 55 to the concave cam 53 by the coned disc spring 57. A torque of the crankshaft 16 is transmitted to the crankshaft output gear 50 in order of the collar 52, the lifter 54, the convex cam 55, the concave cam 53 and the crankshaft output gear 50. When an impact torque of the internal combustion engine is transmitted to the crankshaft 16, the convex cam 55 slips on a cam surface of the concave cam 53 in the circumferential direction and, at the same time, gets over an inclined surface of the concave cam 53, moves in the axial direction against a biasing force of the coned disc spring 57 and absorbs the impact torque. Thus, the torque with the attenuated impact is transmitted to the balancer shafts 39A, 39B (FIG. 2) via the crankshaft output gear 50.

In FIG. 4, the rear balancer shaft 39B is rotatably supported on the left power unit casing 6 and the right unit cover 9 via ball bearings 59, 60. A rear balancer shaft input gear 61B is mounted by spline fitting between the right power unit casing 7 and the right unit cover 9. A rear balancer 62B is engaged with the rear balancer 39B by spline fitting in a state wherein the rear balancer 62B is sandwiched between a pair of crank webs of the crankshaft 16 and is rotated at the same speed as the crankshaft 16. A balancer shaft output gear 63 having a small diameter is fixed to a boss portion of the rear balancer shaft input gear 61B by press fitting and is meshed with a transmission input gear 78 having a large diameter which is fixed to a transmission input clutch 75 of the CVT drive shaft 40. Thus, the rotation is transmitted with the reduction of the rotational speed.

A partition wall 65 is formed on a portion where the left power unit casing 6 and the right power unit casing 7 abut each other thus forming a transmission chamber 67 partitioned from a crank chamber 66. “Transmission” is a general term for a plurality of devices in the inside of the transmission chamber 67. A continuously variable transmission (CVT) 85 is housed in the inside of the transmission chamber 67. The continuously variable transmission 85 includes a CVT drive pulley 86, a CVT driven pulley 92 and an endless metal belt 99. Three transmission shafts, that is, the CVT drive shaft 40, the CVT driven shaft 41 and the transmission output shaft 42 are arranged in the transmission chamber 67. The CVT drive shaft 40 is rotatably supported on the left power unit casing 6 and the right power unit casing 7 via ball bearings 68 (not shown in the drawing), 69. The CVT driven shaft 41 is rotatably supported on the left power unit casing 6 and the right power unit casing 7 via ball bearings 70, 71. The transmission output shaft 42 is rotatably supported on the left power unit casing 6 and the right power unit casing 7 via ball bearings 72, 73.

The transmission input clutch 75 is mounted on a right end portion of the CVT drive shaft 40 which is sandwiched between the right power unit casing 7 and the right unit cover 9. The transmission input clutch 75 is a hydraulic-driven-type multiple disc clutch which transmits power applied to the CVT drive shaft 40 from the rear balancer shaft 39B at the time of normal operation. A clutch outer 76 of the transmission input clutch 75 is fixed to a right end portion of the CVT drive shaft 40 by spline fitting. A clutch inner 77 of the transmission input clutch 75 is fitted in a boss portion of the clutch outer 76 in a relatively rotatable manner. A transmission input gear 78 is fixed to a boss portion of the clutch inner 77 and is rotated together with the clutch inner 77. The transmission input gear 78 is meshed with the balancer shaft output gear 63 of the rear balancer shaft 39B. A plurality of drive friction discs are mounted on the clutch inner 77 in a state wherein the drive friction discs are non-rotatable relative to the clutch inner 77 and are movable in the axial direction and are formed on the clutch inner 77. A plurality of driven friction discs are mounted on the clutch outer 76 in a state wherein driven friction discs are non-rotatable relative to the clutch outer 76 and are movable in the axial direction. The clutch inner 77 and the clutch outer 76 alternately overlap each other to form a group of friction discs 79. A pressure receiving plate 81 is fixed to an opening side of the clutch outer 76 in a state wherein the pressure receiving plate 81 is brought into contact with the group of friction discs 79, and a pressurizing plate 82 which is movable in the axial direction pushes another side of the group of friction discs 79. A transmission input clutch oil chamber 83 is formed between the clutch outer 76 and the pressurizing plate 82. A coil spring 84 is arranged close to the oil chamber 83 and pushes the pressurizing plate 82 in the direction to disengage the clutch.

At the time of starting the internal combustion engine, the pressurizing plate 82 is pushed in the direction to disengage the transmission input clutch 75 using the coil spring. Thus, the clutch is disengaged. Accordingly, when the starter motor 46 rotates the crankshaft 16 via the starter pinion gear 47A, the first idle gear 47B, the second idle gear 47C and the starter driven gear 48, the power is disconnected between the crankshaft 16 and the transmission. Thus, for example, the CVT drive pulley 86 or the start clutch 101 according to this embodiment is not rotated whereby, it is possible to reduce a load applied to a starting device (starter motor 46 in this embodiment). Further, the power transmission device can also obtain the CVT protection effect. When the starting of the internal combustion engine is finished and it is determined that the internal combustion becomes an operational state due to a fact that a rotational speed of the internal combustion engine arrives at a predetermined rotational speed or more, a solenoid valve 135 for transmission input clutch is controlled so as to supply engine oil at a low pressure to the transmission input clutch oil chamber 83. Thus, the pressurizing plate 82 is pushed against the biasing force of the coil spring. 84 and hence, the transmission input clutch 75 is connected.

A CVT drive pulley 86 is arranged at a portion of the CVT drive shaft 40 sandwiched between the left and right power unit cases 6, 7. The drive pulley 86 includes a drive pulley fixed half body 87 and a drive pulley movable half body 88. The fixed half body 87 is integrally formed with the CVT drive shaft 40. Thus, the fixed half body 87 is not movable in the axial direction and is not rotatable relative to the CVT drive shaft 40. The drive pulley movable half body 88 is mounted on a right side of the drive pulley fixed half body 87. The movable half body 88 is mounted on the CVT drive shaft 40 using a key 89 in a state wherein the movable half body 88 is not rotatable relative to the CTV drive shaft 40 but is movable in the axial direction. A CVT drive pulley oil chamber 91 is formed between the movable half body 88 and the partition plate 90. Oil pressure of the oil for the continuously variable transmission is configured to be applied to the oil chamber 91. A distance between the fixed half body 87 and the movable half body 88 is controlled by adjusting the oil pressure of the oil for the continuously variable transmission applied to the oil chamber 91 by way of a hydraulic control valve unit 136. When the pressure in the oil chamber 91 becomes high, the drive pulley movable half body 88 is pushed in the direction to make the drive pulley movable half body 88 approach the drive pulley fixed half body 87.

A CVT driven pulley 92 is formed on a portion of the CVT driven shaft 41 sandwiched between the left and right power unit casings 6, 7. The driven pulley 92 includes a driven pulley fixed half body 93 and a driven pulley movable half body 94. The fixed half body 93 is integrally formed with the CVT driven shaft 41. Accordingly, the fixed half body 93 is not movable in the axial direction and is not rotatable relative to the CVT driven shaft 41. The driven pulley movable half body 94 is mounted on the left side of the driven pulley fixed half body 93. The movable half body 94 is mounted on the CVT driven shaft 41 using a key 95 (not shown in the drawing) in a state wherein the movable half body 94 is not rotatable relative to the CTV driven shaft 41 but is movable in the axial direction. A CVT driven pulley oil chamber 97 is formed between the movable half body 94 and the fixed partition plate 96. The oil pressure of the oil for the continuously variable transmission is configured to be applied to the oil chamber 97. A distance between the fixed half body 93 and the movable half body 94 is controlled by adjusting the oil pressure of the oil for the continuously variable transmission applied to the oil chamber 97 by way of the hydraulic control valve unit 136. A coil spring 98 is arranged in the oil chamber 97 and always pushes the driven pulley movable half body 94 in the direction which makes the driven pulley movable half body 94 approach the driven pulley fixed half body 93. When the pressure in the oil chamber 97 becomes high, the driven pulley movable half body 94 is pushed in the direction which makes the driven pulley movable half body 94 further approach the driven pulley fixed half body 93.

An endless metal belt 99 extends between the CVT drive pulley 86 and the CVT driven pulley 92 so as to transmit the rotation of the CVT drive pulley 86 to the CVT driven pulley 92. When a distance between the movable half body and the fixed half body is large, a winding radius of the endless metal belt 99 becomes small, while when the movable half body approaches the fixed half body, the winding radius of the endless metal belt 99 becomes large. When a winding radius of the endless metal belt 99 on the drive-pulley-86 side is small and the winding radius of the endless metal belt 99 on the driven-pulley-92 side is large, the rotational speed is decreased, while when the winding radius of the endless metal belt 99 on the drive-pulley-86 side is large and the winding radius of the endless metal belt 99 on the driven-pulley-92 side is small, the rotational speed is increased.

A start clutch 101 is formed on a right side of the CVT driven pulley 92. The start clutch 101 is provided for disconnecting the power transmission from the CVT driven shaft 41 to the transmission output shaft 42. A clutch outer 102 of the start clutch 101 is fixed to the CVT driven shaft 41, and in the inside of the clutch outer 102, a clutch inner 103 is mounted on the CVT driven shaft 41 by way of a ball bearing 104 and a needle bearing 105 in a state wherein the clutch inner 103 is rotatable relative to the CVT driven shaft 41. A plurality of drive friction discs are mounted on the clutch outer 102 in a state wherein the drive friction discs are not rotatable relative to the clutch outer 102 but are movable in the axial direction. A plurality of driven friction discs are mounted on the clutch outer 103 in a state wherein the driven friction discs are not rotatable relative to the clutch outer 103 but are movable in the axial direction. The drive friction discs and the driven friction discs alternately overlap each other to form a group of friction discs 106. A pressure receiving plate 108 is fixed to an opening end of the clutch outer 102 in a state wherein the pressure receiving plate 108 is brought into contact with the group of friction discs 106, and a pressurizing plate 109 which is movable in the axial direction pushes another side of the group of friction discs. A start clutch oil chamber 110 is formed between the clutch outer 102 and the pressurizing plate 109 and an oil pressure of the oil for the continuously variable transmission is configured to be applied to the start clutch oil chamber 110. A coil spring 111 is arranged close to the start clutch oil chamber 110 and pushes the pressurizing plate 109 in the direction to disconnect the clutch. When the oil pressure of the oil for the continuously variable transmission is applied to the pressurizing plate 109 by way of the hydraulic control valve unit 136, the pressurizing plate 109 is pushed against the biasing force of the coil spring 111 thus engaging the start clutch 101.

A CVT output gear 112 having a small diameter is integrally formed with a boss portion of the clutch inner 103. The CVT output gear 112 is meshed with an output shaft gear 114 having a large diameter which is mounted at a right end of the transmission output shaft 42 by spline fitting. When the start clutch 101 is engaged, a rotational speed of the CVT driven shaft 41 is decreased and is transmitted to the transmission output shaft 42. A bevel gear 115 is integrally formed on a left end of the transmission output shaft 42. Further, a bevel gear 116 is also integrally formed on a front end of the connection shaft 43 and is meshed with the bevel gear 115 of the transmission output shaft 42. A spline 117 is formed on an end portion of the connection shaft 43 to be connected with an extension shaft for the driving rear wheel (not shown in the drawing) by the spline 117. By way of these shafts, a metal belt and gears, a rotational output of the crankshaft 16 is transmitted to the rear wheel.

In FIG. 2, on a lower portion of the power unit 1, a low-pressure oil pump 120 and a high-pressure oil pump 128 are mounted. The low-pressure oil pump 120 is rotatably driven by a drive chain 124 extending between and wound around a drive sprocket wheel 121 which is mounted on the rear-side balancer shaft 39B and a driven sprocket wheel 123 which is mounted on a lower pressure oil pump shaft 122. The low-pressure oil pump 120 sucks up the engine oil from an oil pan 125 mounted on the lower portion of the power unit 1 by way of an oil strainer 126, and feeds the oil to the inside of the internal combustion engine 2, to a lubricating portion in the inside of the crank chamber 66 and to the transmission input clutch 75. The engine oil is fed to the transmission input clutch 75 by way of a solenoid valve 135 for transmission input clutch when a rotational speed of the internal combustion engine exceeds a predetermined value. While the engine oil is fed to the transmission input clutch 75 for reducing friction of a metal sliding portion, the engine oil is also fed to an oil chamber 83 of the transmission input clutch 75 for driving the pressurizing plate 82.

The high-pressure oil pump 128 is rotatably driven by a drive chain 132 extending between and wound around a drive sprocket 129 which is mounted on the CVT driven shaft 41 and a driven sprocket 131 which is mounted on the high-pressure oil pump shaft 130, and the high-pressure oil pump 128 sucks up the oil for the continuously variable transmission from an oil pan (not shown in the drawing) in the lower portion by way of an oil strainer (not shown in the drawing), and feeds the oil to the CVT drive pulley movable half body 88, the driven pulley movable half body 94, the endless metal belt 99 and the start clutch 101 by way of the hydraulic control valve unit 136. The oil pans for both pumps are separately provided so that respective oils are not mixed. The oil for the continuously variable transmission is supplied to the oil chamber 91 of the drive pulley movable half body 88 and the oil chamber 97 of the driven pulley movable half body 94 and drives the respective half bodies. Further, the oil for the continuously variable transmission is supplied to the oil chamber 110 of the start clutch 101 and is used for driving the pressurizing plate 109. The oil for the continuously variable transmission has a function of enhancing a friction force compared to the engine oil. Thus, it is possible to prevent a slippage at a contact portion between the endless metal belt 99 and the drive pulley 86 and at a contact portion between the endless metal belt 99 and the driven pulley 92. The oil for the continuously variable transmission is, in addition to the above-mentioned purposes, used for lubrication of the inside of the transmission chamber.

In FIGS. 2 to 4, the hydraulic control valve unit 136 is mounted on an upper surface of a rear portion of the left power unit casing 6. The oil for the continuously variable transmission, which is supplied to this device, is fed to the CVT drive pulley oil chamber 91, the CVT driven pulley oil chamber 97, the start clutch oil chamber 110 and the like in such a manner that timings and pressures for these parts are respectively controlled. The changeover of the oil pressures for controlling these parts is performed using solenoid valves by way of spool valves arranged in the inside of the hydraulic control valve unit 136.

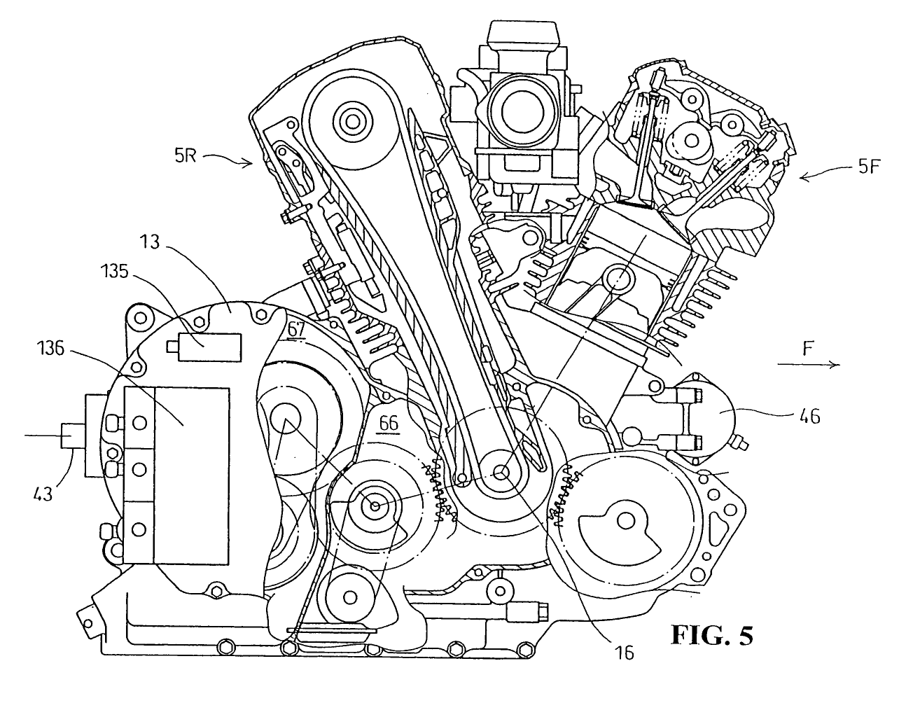

FIG. 5 is a right side view of a power unit 1 according to a second embodiment of the invention. In this embodiment, a hydraulic control valve unit 136 is mounted on an outer surface of a right-outer-side protection cover 13 of a rear portion of the power unit 1. Since the hydraulic control valve unit 136 is arranged close to a transmission chamber 67 in which devices to be supplied with oil are housed, such an arrangement is useful for shortening a length of an oil-passage piping.

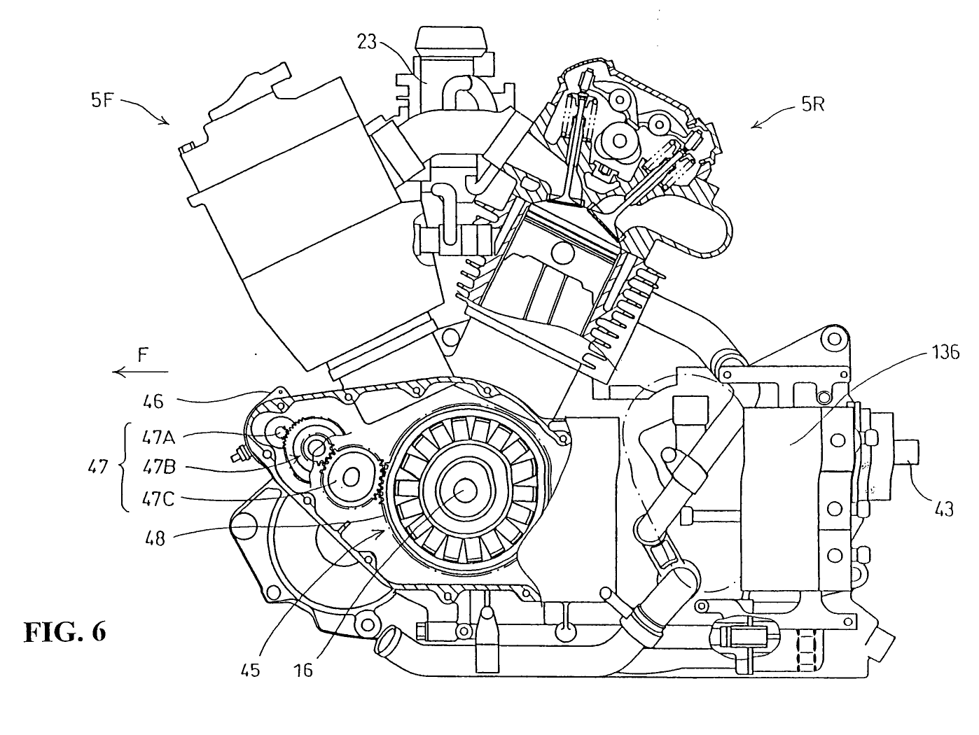

FIG. 6 is a left side view of a power unit 1 according to a third embodiment of the invention. In this embodiment, a hydraulic control valve unit 136 is mounted on a left-side outer surface of a rear portion of the power unit 1. Since the hydraulic control valve unit 136 is arranged close to a transmission chamber 67 in which devices to be supplied with oil are housed, such an arrangement is useful for shortening a length of an oil-passage piping.

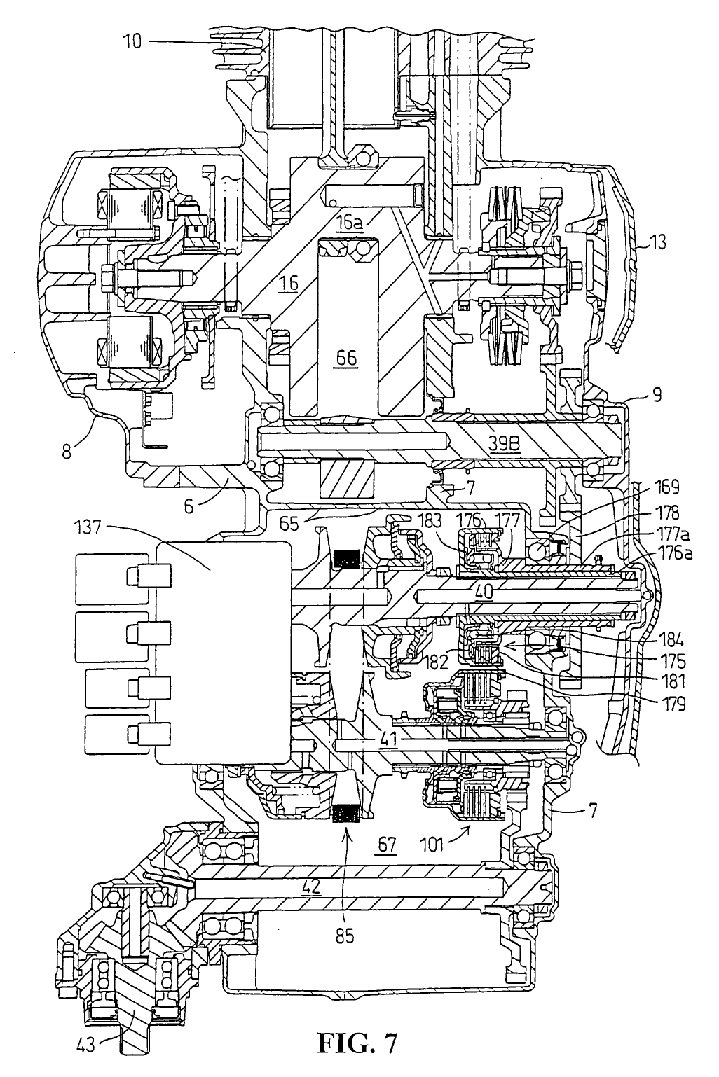

FIG. 7 is a cross-sectional developed view of a power unit 1 which includes respective rotational shafts according to a fourth embodiment of the invention. This embodiment differs from the first embodiment (FIG. 4) with respect to a point that a transmission input clutch 175 is arranged in the inside of a transmission chamber 67. A boss portion 176a of a clutch outer 176 and a boss portion 177a of a clutch inner 177 extend to a right side of a right power-unit case 7 through the inside of an inner lace of a ball bearing 169, and a transmission input gear 178 is fixed to the boss portion 177a of the clutch inner. Also in this embodiment, the relative positional relationship among the clutch outer 176, the clutch inner 177, a group of friction discs 179, a pressure-receiving plate 181, a pressurizing plate 182, a transmission-input-clutch oil chamber 183 and a coil spring 184 which are arranged in the inside of a transmission-input clutch 175 is as same as the relationship described in conjunction with the first embodiment.

By housing the transmission input clutch 175 in the inside of the transmission chamber 67, the actuation and the lubrication of this clutch 175 are performed using oil for the continuously variable transmission by way of a hydraulic control valve unit 137 in the same manner as other devices arranged in the inside of the transmission chamber 67. Accordingly, one solenoid valve is added to the hydraulic control valve unit 137. The lubrication of the transmission input gear 178 which remains outside the transmission chamber 67 is performed using engine oil in the same manner as the case explained in conjunction with the first embodiment. When the internal combustion engine reaches a predetermined rotational speed or more, high-pressure oil for the continuously variable transmission is supplied to a transmission-input-clutch oil chamber 183 by controlling the hydraulic control valve unit 137. Thus, a pressurizing plate 182 is pushed against a biasing force of a coil spring 184 thus engaging the transmission input clutch 175.

The embodiments explained in detail heretofore can obtain the following advantageous effects.

By providing the transmission input clutch which disengages the power transmitted from the internal combustion engine to the transmission, a load applied to a starting device when the internal combustion engine starts can be reduced and, at the same time, the CVT can be protected.

(2) By arranging the drive pulley of the continuously variable transmission on the shaft different from the crankshaft and by providing the transmission input clutch to the power input portion of the driving pulley shaft, it is possible to reduce a width of the power unit compared to a case in which the drive pulley and the clutch are mounted on the crankshaft.

(3) With the provision of the partitioning wall which separates the continuously variable transmission and the transmission input clutch from each other, the working oil for driving the movable half body of the continuously variable transmission and the lubricating oil for driving the transmission input clutch can be separated from each other thus preventing the mixing of the working oil and the lubricating oil. Thus, the performance of the oil can be optimized.

(4) Since the continuously variable transmission is driven by oil for the continuously variable transmission and the transmission input clutch is driven by engine oil, with the use of the optimum oils for the respective devices, it is possible to allow the respective devices to exhibit excellent performances.

(5) When the transmission input clutch is provided in the same chamber of the continuously variable transmission, the same oil can be used for the continuously variable transmission and the clutch thus simplifying the control mechanism.

(6) By arranging the drive pulley of the continuously variable transmission on the shaft different from the crankshaft behind the crankshaft and approximately at the center in the lateral direction of the power unit, it is possible to suppress the lateral width of a power unit. By arranging the drive pulley and the driven pulley in the vertical direction, the longitudinal length of the power unit can be shortened. Due to such a constitution, both of the lateral width and the longitudinal length of the power unit can be shortened.

Here, in the embodiments of the invention, the belt-type transmission is adopted as the continuously variable transmission. However, the invention may be applicable to the power transmission device which adopts a toroidal continuously variable transmission or a hydrostatic continuously variable transmission as the continuous variable transmission. Further, a saddle-ride-type vehicle such as a motorcycle includes a small-sized four-wheeled vehicle for an all terrain vehicle or a tiltable three-wheeled vehicle.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A power transmission device for transmitting power of an internal combustion engine to an output side by way of a transmission comprising:
a start clutch for connecting the power transmitted from the transmission to the output side when the vehicle starts and for disconnecting the power when the vehicle stops; and
a transmission input clutch for disconnecting the power transmitted from the internal combustion engine to the transmission when the internal combustion engine starts.

2. The power transmission device according to claim 1, wherein a continuously variable transmission is arranged between a crankshaft and a transmission output shaft in a side view of a power unit and, at the same time, the transmission input clutch for disconnecting the power when the internal combustion engine starts is arranged on a drive pulley shaft of the continuously variable transmission.

3. The power transmission device according to claim 2, wherein the transmission input clutch is arranged in another chamber isolated from the continuously variable transmission.

4. The power transmission device according to claim 3, wherein the continuously variable transmission is driven using oil for the continuously variable transmission, and the transmission input clutch is driven using engine oil.

5. The power transmission device according to claim 2, wherein the transmission input clutch is arranged in the same chamber as the continuously variable transmission.

6. The power transmission device according to claim 2, wherein the drive pulley of the continuously variable transmission is arranged on another shaft behind the crankshaft at the approximate center in the lateral direction of the power unit and the drive pulley and a driven pulley of the continuously variable transmission are configured to take positions arranged in the vertical direction.

7. The power transmission device according to claim 1, wherein the transmission input clutch is a hydraulic-driven multiple disc clutch for transmitting power to a drive shaft from a rear balancer shaft during normal operation.

8. The power transmission device according to claim 7, wherein a clutch outer of the transmission input clutch is fixed to an end portion of the drive shaft and a clutch inner of the transmission input clutch is mounted relative to the clutch outer in a rotatable manner.

9. The power transmission device according to claim 8, wherein a transmission input gear is fixed to the clutch inner and is rotated together with the clutch inner, the transmission input gear is meshed with a shaft output gear of a rear balancer shaft, a plurality of drive friction discs are mounted on the clutch inner wherein the drive friction discs are non-rotatable relative to the clutch inner and are movable in an axial direction.

10. The power transmission device according to claim 9, wherein a plurality of driven friction discs are mounted on the clutch outer wherein the driven friction discs are non-rotatable relative to the clutch outer and are movable in the axial direction, a pressure receiving plate is fixed to an opening side of the clutch outer wherein the pressure receiving plate is brought into contact with the group of friction discs and a pressurizing plate is movable in the axial direction for pushing another side of the group of friction discs, a transmission input clutch oil chamber is formed between the clutch outer and the pressurizing plate wherein a biasing member adjacent to the oil chamber pushes the pressurizing plate in a direction to disengage the clutch.

11. A power transmission device adapted for transmitting power of an internal combustion engine to an output comprising:
a transmission adapted to be operatively connected to the power transmission device;
a start clutch for connecting the power transmitted from the transmission to the output when the vehicle starts and for disconnecting the power when the vehicle stops; and
a transmission input clutch for disconnecting the power transmitted from the internal combustion engine to the transmission when the internal combustion engine starts.

12. The power transmission device according to claim 11, wherein a continuously variable transmission is arranged between a crankshaft and a transmission output shaft in a side view of a power unit and, at the same time, the transmission input clutch for disconnecting the power when the internal combustion engine starts is arranged on a drive pulley shaft of the continuously variable transmission.

13. The power transmission device according to claim 12, wherein the transmission input clutch is arranged in another chamber isolated from the continuously variable transmission.

14. The power transmission device according to claim 13, wherein the continuously variable transmission is driven using oil for the continuously variable transmission, and the transmission input clutch is driven using engine oil.

15. The power transmission device according to claim 12, wherein the transmission input clutch is arranged in the same chamber as the continuously variable transmission.

16. The power transmission device according to claim 12, wherein the drive pulley of the continuously variable transmission is arranged on another shaft behind the crankshaft at the approximate center in the lateral direction of the power unit and the drive pulley and a driven pulley of the continuously variable transmission are configured to take positions arranged in the vertical direction.

17. The power transmission device according to claim 11, wherein the transmission input clutch is a hydraulic-driven multiple disc clutch for transmitting power to a drive shaft from a rear balancer shaft during normal operation.

18. The power transmission device according to claim 17, wherein a clutch outer of the transmission input clutch is fixed to an end portion of the drive shaft and a clutch inner of the transmission input clutch is mounted relative to the clutch outer in a rotatable manner.

19. The power transmission device according to claim 18, wherein a transmission input gear is fixed to the clutch inner and is rotated together with the clutch inner, the transmission input gear is meshed with a shaft output gear of a rear balancer shaft, a plurality of drive friction discs are mounted on the clutch inner wherein the drive friction discs are non-rotatable relative to the clutch inner and are movable in an axial direction.

20. The power transmission device according to claim 19, wherein a plurality of driven friction discs are mounted on the clutch outer wherein the driven friction discs are non-rotatable relative to the clutch outer and are movable in the axial direction, a pressure receiving plate is fixed to an opening side of the clutch outer wherein the pressure receiving plate is brought into contact with the group of friction discs and a pressurizing plate is movable in the axial direction for pushing another side of the group of friction discs, a transmission input clutch oil chamber is formed between the clutch outer and the pressurizing plate wherein a biasing member adjacent to the oil chamber pushes the pressurizing plate in a direction to disengage the clutch.
